(19) United States
(12) Patent Application Publication
(10) Pub. No.: US 2020/0331379 A1
(43) Pub. Date: Oct. 22, 2020

(54) Mobile Tower System

(71) Applicant: Peak Industries, Inc., Spokane, WA (US)

(72) Inventor: Gerald W. Newman, Spangle, WA (US)

(21) Appl. No.: 16/855,227

(22) Filed: Apr. 22, 2020

Related U.S. Application Data
(60) Provisional application No. 62/837,074, filed on Apr. 22, 2019.

(51) Int. Cl. B60P 1/54; B66C 23/80; B60P 1/16; B60P 1/04

(52) U.S. Cl. CPC B60P 1/5461; B60P 1/045; B60P 1/162; B66C 23/80

(57) ABSTRACT

A mobile tower system including a tower skid assembly sized to be accommodated on a truck. The tower skid assembly including a skid including one or more ballast compartments, a tower framework fixed to a deck, a tower pivotably coupled to the tower framework, and a hydraulic actuator connected to a top member of the tower to extend the top member a vertical distance relative to a base member of the tower.

### RELATED APPLICATION

This application claims the benefit of priority from U.S. Provisional Application No. 62/837,074, filed Apr. 22, 2019, and entitled “Mobile Tower System,” which is incorporated herein by reference.

### BACKGROUND

Mobile tower systems often implement pneumatic towers. For example, pneumatic towers may be installed in a van. However, because these towers are pneumatic they are relatively fragile and prone to failure. For example, the seals (e.g., gaskets, O-rings, etc.) may be relatively fragile and may be prone to fail especially in adverse conditions. Accordingly, there remains a need for mobile tower systems that are more robust.

### SUMMARY

Mobile tower systems that are removeably loadable on a truck are described herein. More specifically, this disclosure relates to mobile tower systems that have a tower skid assembly that is removeably loadable on a truck. This summary is provided to introduce simplified concepts of mobile tower systems, which are further described below in the Detailed Description. This summary is not intended to identify essential features of the claimed subject matter, nor is it intended for use in determining the scope of the claimed subject matter.

In an embodiment, a mobile tower system includes a tower skid assembly removeably loadable on a back of a truck. The tower skid assembly may include a skid including one or more ballast compartments for containing a ballast. A tower framework may be fixed to a deck. A tower may be pivotably coupled to the tower framework. The ballast of the skid may provide for guy lines attached to the tower to be attached to the skid. The tower may include a base member and a top member longitudinally aligned with the base member. The top member may be extendable a vertical distance relative to the base member. The tower skid assembly may include an actuator connected to the top member to extend the top member the vertical distance relative to the base member. A piece of equipment may be fixed to the top member.

In an embodiment, a mobile tower system includes a tower skid assembly sized to be accommodated on a back of a truck. The tower skid assembly may include a skid. A tower framework may be fixed to a deck. A tower may be pivotably coupled to the tower framework. A hoist mechanism may be disposed on the back of the truck for removeably loading the skid. A lifting member may be fixed to a front of the skid. When the skid is removeably loaded on the back of the truck, the lifting member may be disposed proximate to a cab of the truck and the tower framework fixed to the deck may be disposed proximate to a back end of the bed of the truck. When the skid is unloaded from the back of the truck, the tower may be pivoted between a stowed position and a use position. When in the stowed position the tower may be horizontally disposed proximate to the deck, and when in the use position the tower is vertically disposed proximate to the deck. A piece of equipment may be fixed to a top member of the tower. The skid may include a ballast that provides for guy lines attached to the tower to be attached to the skid.

Depending on the desired esthetic and mechanical properties of the mobile tower system, and a piece of equipment that the mobile tower system is intended to carry, components may be formed of metal, plastic, and/or ceramic.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates a side view of an exemplary mobile tower system with a tower skid assembly removeably loaded on a truck according to an embodiment in this disclosure.

FIG. 2 illustrates a perspective view of the tower skid assembly of FIG. 1 according to an embodiment in this disclosure.

FIG. 3 illustrates a side view of the tower skid assembly of FIG. 1 according to an embodiment in this disclosure.

FIG. 4 illustrates a top view of the tower skid assembly of FIG. 1 according to an embodiment in this disclosure.

FIG. 5 illustrates a side view of the truck of FIG. 1 with a hoist mechanism disposed on a back of the truck for removeably loading the tower skid assembly according to an embodiment in this disclosure.

FIG. 6 illustrates another side view of the truck of FIG. 1 with the hoist mechanism disposed on the back of the truck for removeably loading the tower skid assembly according to an embodiment in this disclosure.

FIG. 7 illustrates another side view of the truck of FIG. 1 with the hoist mechanism disposed on the back of the truck for removeably loading the tower skid assembly according to an embodiment in this disclosure.

### DETAILED DESCRIPTION

### Overview

This disclosure is directed to mobile tower systems having a tower skid assembly sized to be accommodated on a truck. As such, a user may quickly and easily load the tower skid assembly on any truck as desired. Moreover, a higher portability of mobile tower systems is achieved as compared to trailered tower systems.

In an example, a mobile tower system includes a hydraulic actuator connected to a top member of a tower. The hydraulic actuator may extend the top member a vertical distance relative to a base member of the tower. Therefore, the mobile tower systems may be more robust relative to systems utilizing a pneumatic tower.

In another example, a mobile tower system includes one or more ballast compartments. The one or more ballast compartments may removeably contain ballast. An amount of the ballast may be based at least in part on a maximum weight capacity of a truck. The ballast contained in the one or more ballast compartments may provide for guy lines attached to the tower to be attached to the skid. As such, the mobile tower system has a relatively smaller footprint, thus reducing a cost of real estate associated with deploying the mobile tower system.

### Illustrative Mobile Tower Systems

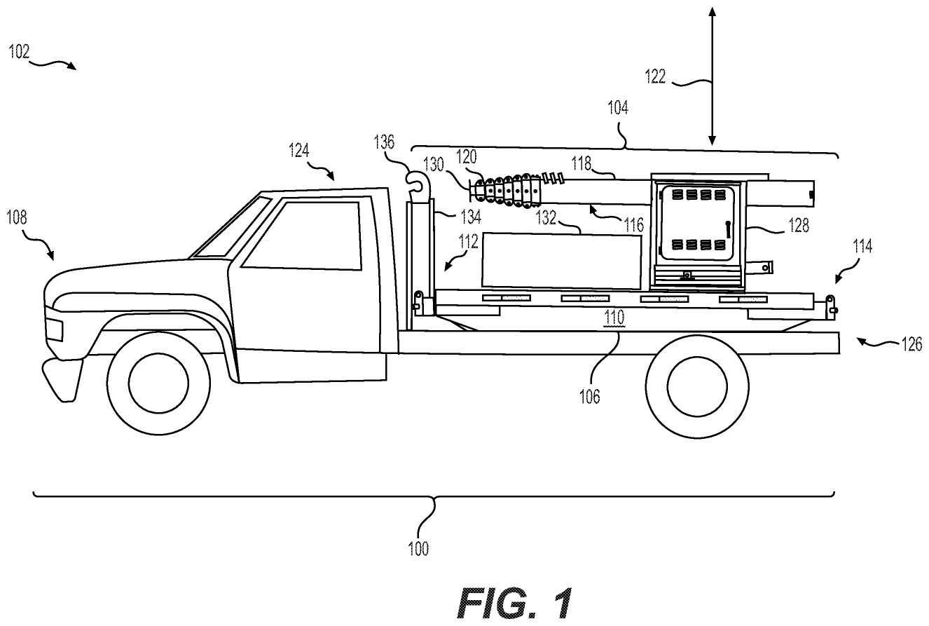

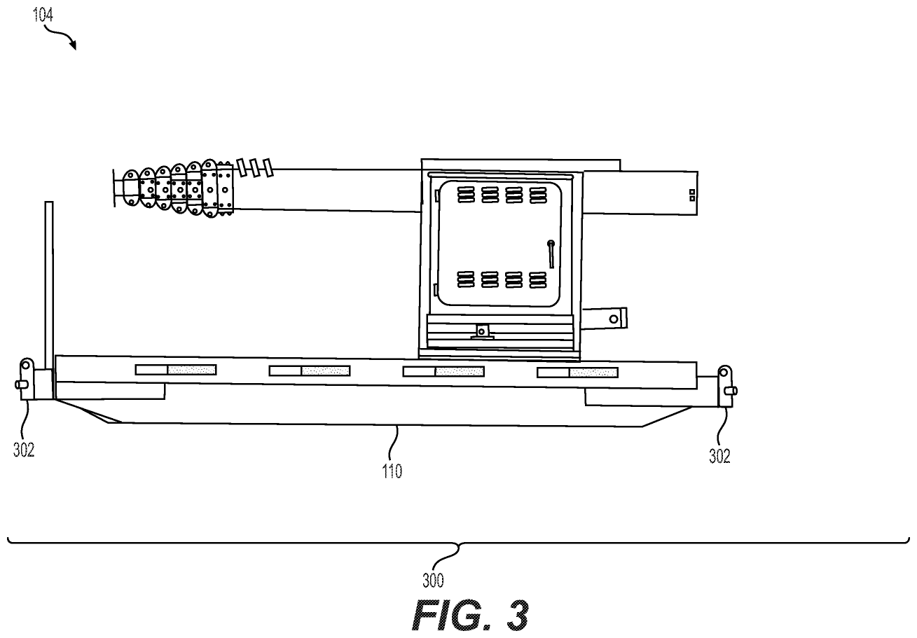

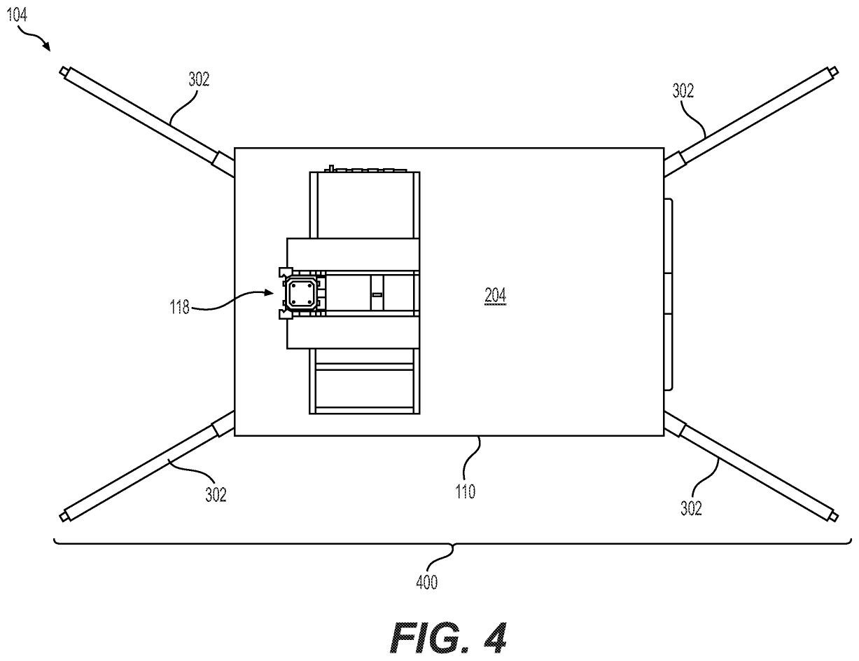

FIG. 1 illustrates a side perspective view 100 of an exemplary mobile tower system 102 with a tower skid assembly 104 removeably loaded on a back 106 of a truck 108. The tower skid assembly 104 may include a skid 110 having a front portion 112 opposite a back portion 114. The skid 110 may include one or more ballast compartments for containing a ballast (not shown). For example, one or more ballast compartments may be disposed in the skid 110 for containing the ballast. The one or more ballast compartments may be disposed in the skid 110 between outriggers moveably disposed in the skid 110 (discussed in more detail below with regard to FIG. 3 and FIG. 4). One or more leveling mechanisms may be fixed to the skid 110. The one or more leveling mechanisms may provide for leveling the tower skid assembly 104 when the tower skid assembly 104 is disposed on a surface.

The tower skid assembly 104 may include a tower 116. While FIG. 1 illustrates the tower 116 may be pivotably coupled to the skid 110, the tower 116 may be fixed vertically to the skid 110. The tower 116 may include a base member 118 and a top member 120. The top member 120 may be longitudinally aligned with the base member 118. The top member 120 may be extendable a vertical distance 122 relative to the base member 118. The tower 116 may be extendable a vertical distance of about 60 feet. For example, the tower 116 may include a plurality of members longitudinally aligned between the top member 120 and the base member 118, and the plurality of members and the top member 120 may each extend at least a portion of the vertical distance 122 relative to the base member 118. The top member 120, the base member 118, and the plurality of members may be telescoping segments. Each of the top member 120, the base member 118, and the plurality of members may be rectangular tubes. The top member 120, the base member 118, and/or the plurality of members may include or be formed of metal (e.g., steel, aluminum, titanium, etc.), composite (e.g., carbon fiber, fiberglass, etc.), plastic, etc.

The tower 116 may utilize shims arranged between the top member 120, the base member 118, and/or the plurality of members. The shims may align each of the members along the longitudinal length of the tower 116. There may be bottom shims disposed on a bottom portion of a member that slideably engages with an inside surface of another member. There may be top shims disposed on a top portion of a member that slideably engages with an outside portion of another member. The shims may be made of plastic, composite, metal, fiber, etc.

An actuator may be connected to the top member 120 to extend the top member 120 the vertical distance 122 relative to the base member 118. The actuator may be arranged inside of the top member 120 and inside of the base member 118. The actuator may be arranged inside of the plurality of members. The actuator may be a hydraulic actuator. The hydraulic actuator may be a one push hydraulic cylinder. The actuator may be capable of lifting about 5,000 pounds.

When the tower skid assembly 104 is removeably loaded on the truck 108, the front portion 112 of the skid 110 may be disposed proximate to a cab 124 of the truck 108 and the back portion 114 of the skid 110 may be disposed proximate to a back end 126 of the back 106 of the truck 108.

The tower skid assembly 104 may include a cabinet 128. The cabinet 128 may be fixed to the deck. The tower skid assembly 104 may include a hydraulic pump. The hydraulic pump may power the hydraulic actuator. The hydraulic pump may be housed in the cabinet 128. One or more hydraulic reservoirs and or components may be housed inside of the cabinet 128. The one or more hydraulic reservoirs and or components housed inside of the cabinet 128 may be connected to the hydraulic pump and/or the hydraulic actuator. The cabinet 128 may include one or more doors to provide access to the inside of the cabinet 128 and access to equipment mounted inside the cabinet 128.

The tower skid assembly 104 may include a mounting member 130 fixed to the top member 120. The mounting member 130 may have a free end for mounting a piece of equipment thereto. The piece of equipment may be a camera, an antenna, a radar, etc. The mobile tower system 102 may utilize the piece of equipment in a security environment, a border patrol environment, a military environment, a wireless environment, a cell cite environment, a micro cell environment, a fast deployment environment (e.g., an emergency environment, a firefighting environment, etc.).

The tower skid assembly 104 may include a remote control operable to move the tower 116 between the stowed position and the use position. For example, the tower skid assembly 104 may include a remote control that a user may operate remotely to move the tower 116 between the stowed position and the use position. The remote control may be operable to extend the tower 116 the vertical distance 122. For example, a user may operate the remote control to extend the tower 116 the vertical distance 122. The user may operate the remote control to retract the tower 116. The user may operate the remote control to extend the tower 116 to any vertical distance less than the vertical distance 122.

The tower skid assembly 104 may include a cabinet 132. The cabinet 132 may be fixed to the deck. The cabinet 132 may include racks fixed on an inside surface of the cabinet 132. The racks may provide for mounting one or more pieces of equipment thereto. For example, radio equipment, wireless equipment, cell equipment, etc. may be mounted to the racks fixed on inside surfaces of the cabinet 132. The cabinet 132 includes one or more doors to provide access to the inside of the cabinet 132 and access to equipment mounted inside the cabinet 132. While FIG. 1 illustrates the tower skid assembly 104 may include two cabinets, cabinet 128 and cabinet 132, the tower skid assembly 104 may include a single cabinet for housing the equipment. The single cabinet may further house at least a portion of the tower 116. For example, the single cabinet may house the mounting member 130 and may have the free end for mounting a piece of equipment thereto.

A user may removeably dispose ballast contained in the one or more ballast compartments disposed in the skid 110 based at least in part on a maximum weight capacity of the truck 108. For example, a user may removeably dispose ballast in the one or more compartments to adjust an amount of weight of the ballast contained in the one or more ballast compartments so that a total weight of the tower skid assembly 104 is about the same as a maximum weight capacity of the truck 108. In one example, the total weight of the tower skid assembly 104 may be less than the maximum weight capacity of the truck 108 because of a relatively low weight of the amount and/or type of equipment fixed inside of the cabinet 132. In this example, a user may add ballast to the one or more ballast compartments to increase the total weight of the tower skid assembly 104 to be the same as the maximum weight capacity of the truck 108. In another example, the total weight of the tower skid assembly 104 may be greater than the maximum weight capacity of the truck 108 because of a relatively high weight of the amount and/or type of equipment fixed inside of the cabinet 132. In this example, a user may remove ballast from the one or more ballast compartments to decrease the total weight of the tower skid assembly 104 to be the same as the maximum weight capacity of the truck 108.

The tower skid assembly 104 may include a hoisting member 134 fixed to the skid 110. The hoisting member 134 may be fixed to the front portion 112 of the skid 110. The hoisting member 134 may be formed of a plurality of bars and/or tubes. The hoisting member 134 may provide for a hoist mechanism 136 disposed on the back 106 of the truck 108 to load or unload the tower skid assembly 104.

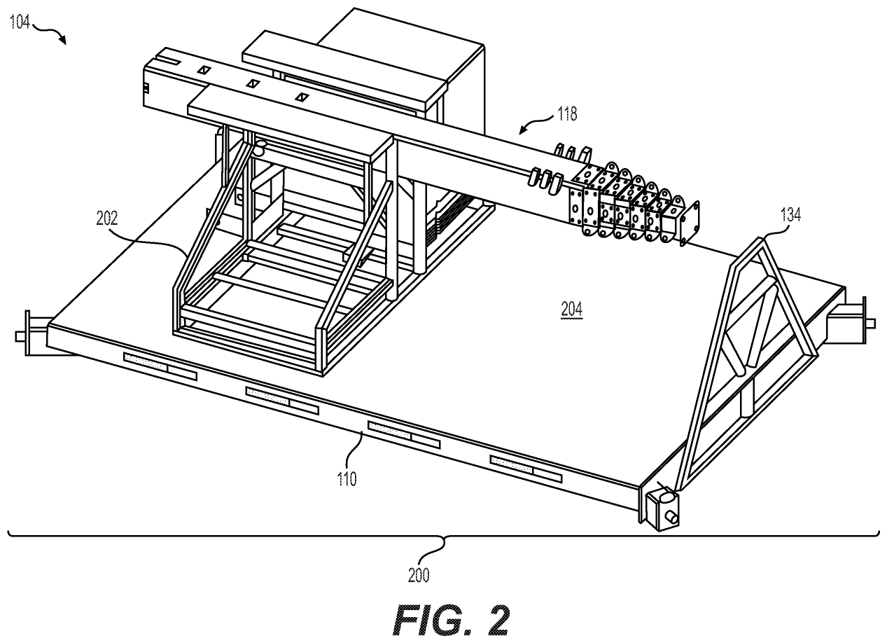

FIG. 2 illustrates a perspective view 200 of the tower skid assembly 104 of FIG. 1 according to an embodiment in this disclosure. FIG. 2 illustrates the tower skid assembly 104 may include a tower framework 202 may be fixed to a deck 204 of the skid 110. The framework 202 may be formed of a plurality of bars and/or tubes. The tower 116 may be pivotably coupled to the tower framework 202. As discussed above, the base member 118 may extend in a length direction and may be oriented such that the length direction extends vertically adjacent to the back portion 114 of the skid 110. The top member 120 may be vertically aligned with the base member 118.

FIG. 3 illustrates a side view 300 of the tower skid assembly 104 of FIG. 1 according to an embodiment in this disclosure. FIG. 3 illustrates the tower skid assembly 104 may include one or more outriggers 302. The one or more outriggers 302 may be moveably disposed in the skid 110. The one or more outriggers 302 may be moveable between a retracted position and an extended position. FIG. 3 illustrates the one or more outriggers 302 may be disposed in the skid 110 when the one or more outriggers 302 are in the retracted position. When the one or more outriggers 302 are in the extended position, the one or more outriggers 302 may be disposed outside of the skid 110 (discussed in more detail below with regard to FIG. 4).

FIG. 4 illustrates a top view 400 of the tower skid assembly 104 of FIG. 1 according to an embodiment in this disclosure. FIG. 4 illustrates the one or more outriggers 302 are in an extended position. When the one or more outriggers 302 are in the extended position, the one or more outriggers 302 may be disposed outside of the skid 110.

FIG. 4 illustrates the tower 116 may be vertically disposed proximate to the deck 204 of the skid 110 when in a use position. In an embodiment, when the tower 116 is in the use position, one or more guy lines (not shown) may be attached to the tower 116 and may be guyed back to the one or more outriggers 302 in either the extended position or the retracted position, or back to the skid 110. One or more ballast compartments may be disposed in the skid 110 between outriggers moveably disposed in the skid 110.

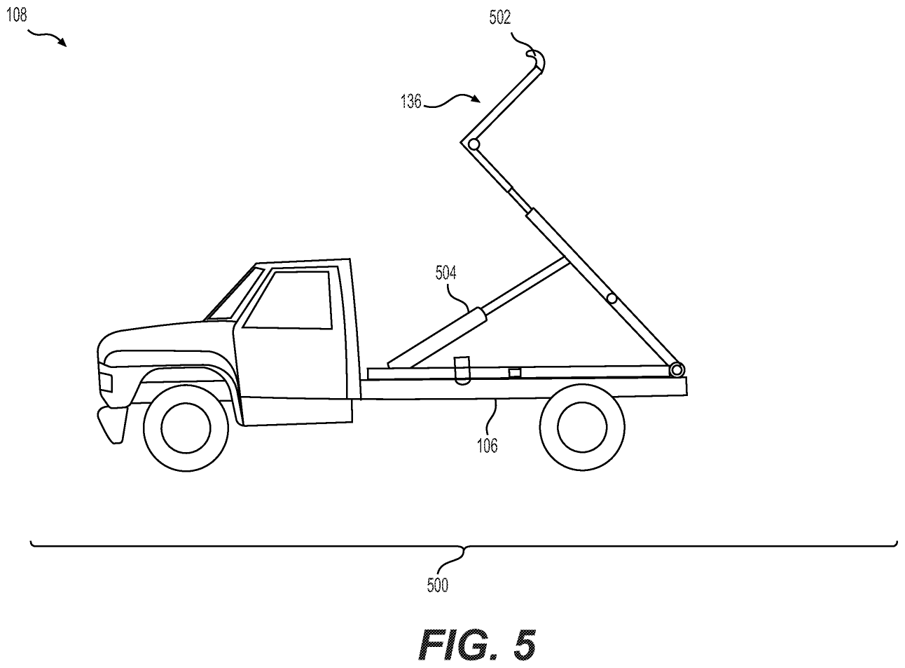

FIG. 5 illustrates a side view 500 of the truck of FIG. 1 with the hoist mechanism 136 disposed on the back 106 of the truck 108 for removeably loading the tower skid assembly 104, according to an embodiment in this disclosure. The hoist mechanism 136 may include a coupling member 502. The coupling member 502 may be configured to couple with the hoisting member 134 fixed to the skid 110. The hoist mechanism 136 may include an actuator 504. The actuator 504 may be attached to a framework of the hoist mechanism 136. The actuator 504 may be a hydraulic actuator. The hydraulic actuator may be a one push hydraulic cylinder. FIG. 5 illustrates the actuator 504 moved the coupling member 502 a distance above the back 106 of the truck 108.

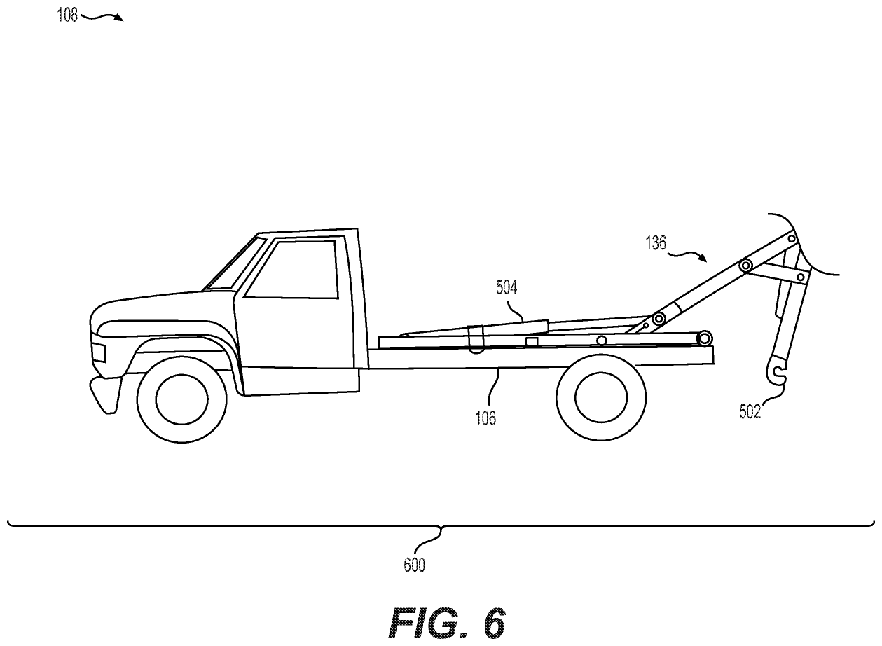

FIG. 6 illustrates another side view 600 of the truck 108 of FIG. 1 with the hoist mechanism 136 disposed on the back 106 of the truck 108 for removeably loading the tower skid assembly 104, according to an embodiment in this disclosure. FIG. 6 illustrates the actuator 504 moved the coupling member 502 a distance behind the truck 108. When the coupling member 502 is disposed a distance behind the truck 108, the tower skid assembly 104 may be unloaded from the truck 108.

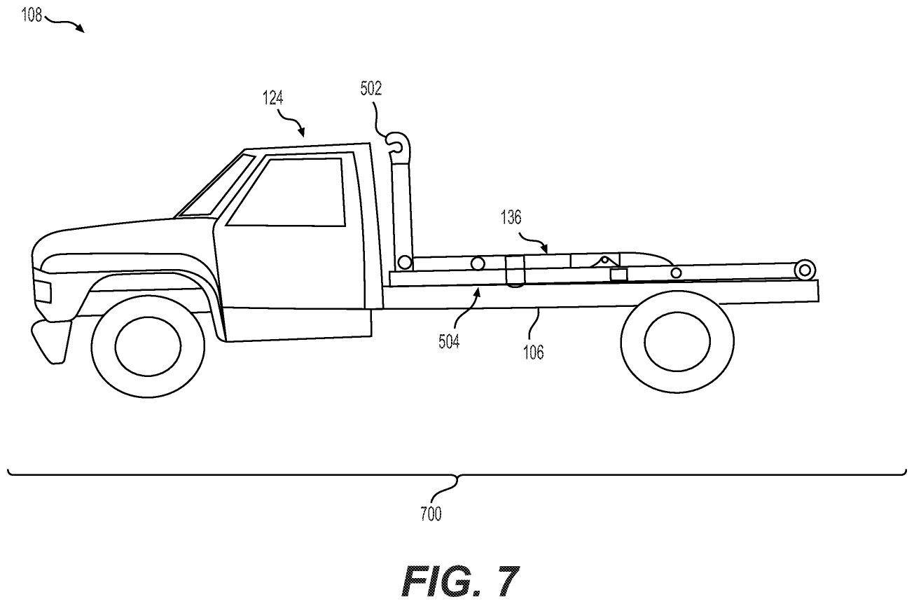

FIG. 7 illustrates another side view 700 of the truck 108 of FIG. 1 with the hoist mechanism 136 disposed on the back 106 of the truck 108 for removeably loading the tower skid assembly 104 according to an embodiment in this disclosure. FIG. 7 further illustrates the actuator 504 moved the coupling member 502 to a position proximate to the cab 124 of the truck 108. When the coupling member 502 is disposed at a position proximate to the cab 124 of the truck 108, the tower skid assembly 104 may be loaded on the back 106 of the truck 108.

### CONCLUSION

Although the invention has been described in language specific to structural features and/or methodological acts, it is to be understood that the invention is not necessarily limited to the specific features or acts described. Rather, the specific features and acts are disclosed as illustrative forms of implementing the invention. For example, while embodiments are described having certain shapes, sizes, and configurations, these shapes, sizes, and configurations are merely illustrative.

What is claimed is:

1. A mobile tower system comprising:
a tower skid assembly removeably loadable on a truck, the tower skid assembly including:
a skid including one or more ballast compartments,
a deck coupled to the skid,
a tower framework fixed to the deck,
a tower pivotably coupled to the tower framework, the tower including a base member and a top member longitudinally aligned with the base member, the top member extendable a vertical distance relative to the base member, and
a hydraulic actuator connected to the top member to extend the top member the vertical distance relative to the base member.

2. The mobile tower system of claim 1, wherein the tower skid assembly further includes a hydraulic pump disposed with the deck, and one or more controls disposed with the deck.

3. The mobile tower system of claim 2, wherein the tower skid assembly further includes a cabinet fixed to the deck, and
wherein the hydraulic pump is housed in the cabinet, or the one or more controls are housed in the cabinet.

4. The mobile tower system of claim 1, wherein the tower is pivotable between a stowed position and a use position,
wherein, when in the stowed position, the tower is horizontally disposed proximate to the deck, and, when in the use position, the tower is vertically disposed proximate to the deck.

5. The mobile tower system of claim 1, wherein the tower skid assembly further includes one or more outriggers moveable between a retracted position and an extended position, and
wherein one or more cables attached to a portion of the top member of the tower are guyed back to the one or more outriggers when the one or more outriggers are in the retracted position or in the extended position.

6. The mobile tower system of claim 1, wherein the tower skid assembly further includes a cabinet fixed to the deck, the cabinet including racks fixed on an inside surface of the cabinet, the racks for mounting one or more pieces of equipment thereto.

7. The mobile tower system of claim 1, wherein the tower skid assembly further includes a hoisting member fixed to an end of the skid.

8. A mobile tower system comprising:
a truck including a hoist mechanism attached to a back portion of the truck;
a tower skid assembly removeably loadable on the truck via the hoist mechanism, the tower skid assembly including:
a skid,
a deck coupled to the skid,
a tower framework fixed to the deck,
a tower pivotably coupled to the tower framework, the tower including a base member and a top member longitudinally aligned with the base member, the top member extendable a vertical distance relative to the base member, and
a hydraulic actuator connected to the top member to extend the top member the vertical distance relative to the base member.

9. The mobile tower system of claim 8, wherein the skid assembly further includes a one or more ballast compartments for removeably containing ballast.

10. The mobile tower system of claim 9, wherein an amount of the ballast is based at least in part on a maximum weight capacity of the truck.

11. The mobile tower system of claim 9, wherein the ballast removeably contained in the one or more ballast compartments provides for one or more cables attached to a portion of the top member of the tower to be guyed back to one or more outriggers.

12. The mobile tower system of claim 8, wherein the tower is pivotable between a stowed position and a use position, and
wherein, when in the stowed position, the tower is horizontally disposed proximate to the deck, and, when in the use position, the tower is vertically disposed proximate to the deck.

13. The mobile tower system of claim 8, wherein the tower skid assembly further includes one or more outriggers moveable between a retracted position and an extended position, and
wherein one or more cables attached to a portion of the top member of the tower are guyed back to the one or more outriggers when the one or more outriggers are in the retracted position or in the extended position.

14. The mobile tower system of claim 8, wherein the tower skid assembly further includes a cabinet fixed to the deck, the cabinet including racks fixed on an inside surface of the cabinet, the racks for mounting one or more pieces of equipment thereto.

15. The mobile tower system of claim 8, wherein the tower skid assembly further includes a hoisting member fixed to an end of the skid.

16. A mobile tower system comprising:
a tower skid assembly removeably loadable on a truck, the tower skid assembly including:
a skid,
a deck coupled to the skid,
a tower framework fixed to the deck,
a tower pivotably coupled to the tower framework, the tower including a base member and a top member longitudinally aligned with the base member, the top member extendable a vertical distance relative to the base member,
a hydraulic actuator connected to the top member to extend the top member the vertical distance relative to the base member,
one or more outriggers moveably disposed in the skid between a retracted position and an extended position, and
wherein one or more cables attached to a portion of the top member of the tower are guyed back to the one or more outriggers when the one or more outriggers are in the retracted position or in the extended position.

17. The mobile tower system of claim 16, wherein the truck includes a hoist attached to the truck, the hoist for removeably loading the tower skid assembly on the truck.

18. The mobile tower system of claim 16, wherein the skid assembly further includes a one or more ballast compartments for removeably containing ballast.

19. The mobile tower system of claim 18, wherein the one or more ballast compartments are disposed in the skid between the one or more outriggers.

20. The mobile tower system of claim 16, wherein the tower is pivotable between a stowed position and a use position, and
wherein, when in the stowed position, the tower is horizontally disposed proximate to the deck, and, when in the use position, the tower is vertically disposed proximate to the deck.
